(19) United States
(12) Patent Application Publication
(10) Pub. No.: US 2007/0101284 A1
(43) Pub. Date: May 3, 2007

(54) Unified tracking of time dependent events

(75) Inventors: Han-yi Shaw, Redmond, WA (US); Kyle T. Richey, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/262,409

(22) Filed: Oct. 28, 2005

(51) Int. Cl. G06F 17/00; G06F 3/00; G06F 15/16

(52) U.S. Cl. 715/772; 715/764; 709/206

(57) ABSTRACT

A notification system with a unified notification panel provides time dependent and other user data in a single page user interface. The data may include reminders and other information associated with user electronic mail, calendar data, and other data. The data in the panel is updated with new data as changes are detected. New or changed data may be accessed from a remote storage device, local memory or some other storage location.

### BACKGROUND

Software applications are valuable tools for managing personal information. For example, personal information management (PIM) applications are used to manage email, calendar and other personal data for a user. Notification applications communicate with PIM applications to allow a user to view and manage email, calendar task or other data in separate pages of a user interface. Other notification applications provide a single page interface, but only provide limited data (e.g., email data or calendar data, but not both).

One challenge for notification applications is maintaining current user data. Different notification applications handle changes to user personal information in different ways. Some notification applications update user data in an interface each time the interface is executed. Thus, the user data is updated once when the application is initialized, but not while it is running. Other notification applications may update user data in response to a local timer event (a periodical update) or in response to user input. Thus, a notification may request an update for user data in response to a user request.

In addition to keeping data current, it is important to notify a user when the user's personal information changes. Previous notification applications are application dependent. That is, a notification application typically only provides notifications for one type of data (for example, web based email provides updates for the email account only). Using different notification systems for different user data makes it difficult to keep track of different types of changing information. It is important for notification applications to provide a simple, accurate, and easy to use user interface for displaying user data.

### SUMMARY

The technology herein, roughly described, pertains to a unified notification panel provided by a notification system. The unified notification panel provides user data in a single page user interface. The user data may include alerts and other information for content such as user electronic mail, calendar data, contact lists, tasks, notes, projects and other data. The user data may be accessed locally or from a remote storage location.

Alerts are provided in the notification panel to notify a user when a state change occurs in the notification application. A state change may correspond to new or updated data associated with the user. The alert may be a visual or audio indicator associated with the new or changed user data. The alerts may be provided in the notification panel while a personal information management application is in communication with the notification application.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for providing a unified notification panel.

FIG. 2 illustrates an embodiment of a computing system for use with the present technology.

FIG. 3A illustrates an embodiment of a user interface for providing personal information for a user.

FIG. 3B illustrates an embodiment of a user interface for providing personal information for a user.

FIG. 3C illustrates an embodiment of a user interface for providing personal information for a user.

FIG. 4 is a flowchart illustrating an embodiment for generating a new data notification for a user

FIG. 5 is a flowchart illustrating an embodiment for providing user data in a user interface.

FIG. 6 is a flowchart of an embodiment for retrieving user data.

### DETAILED DESCRIPTION

A notification system is described below that provides a unified notification panel. The unified notification panel provides time dependent and other user data in a single page user interface. The user data may include reminders and other information associated with user electronic mail, calendar data, contact lists, notes, tasks, projects and other data. Project data can include email, calendar contacts, notes, tasks and other data associated with a common theme. The user data in the panel is updated as changes are detected by the notification application. New user data may be accessed from a remote storage device, local memory or some other storage location. In one embodiment, the notification system allows a user to track how busy one is by displaying the number of emails to be read, the number of tasks to be completed, the time until the next event (appointment or task) is due for the user and a view of how “densely” scheduled the user's day is (via a timeline). Thus, the display can be centered on the overall work-load for the individual for the day. The notification system is discussed in more detail below.

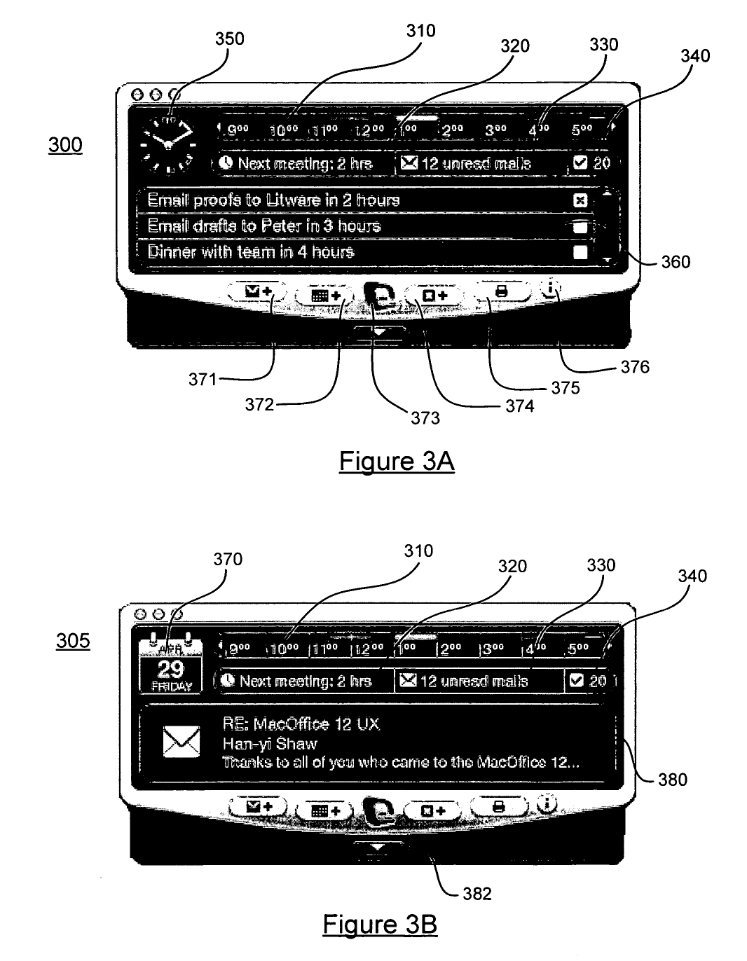

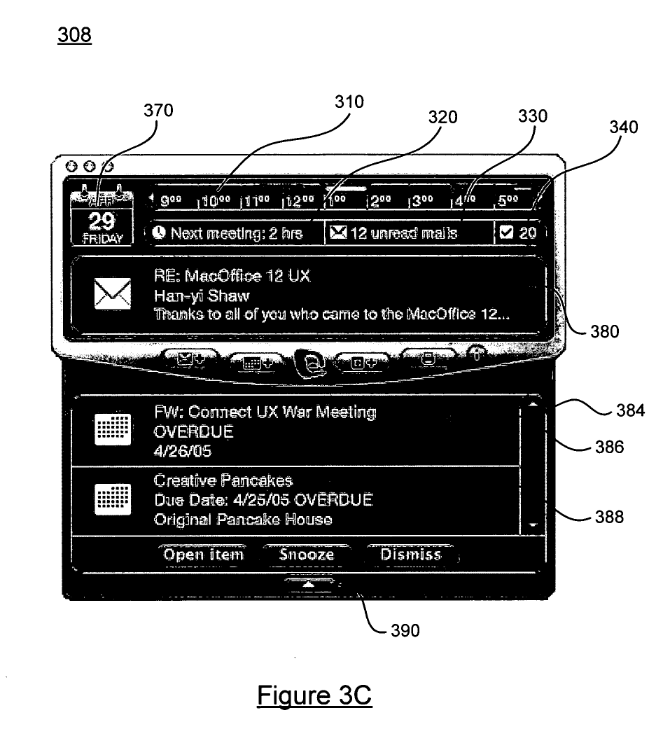

The unified notification panel may provide user data and notifications associated with the user data in a single page of a user interface. That is, user input is not required to switch between more than one page or frame within the interface to see the user data or related notifications. Examples of a single page of a user interface that provide user data and related notifications (e.g., notifications for new or changed user data) are illustrated in FIGS. 3A-3C and discussed in more detail below.

In one embodiment, the notification application is in communication with one or more personal information management (PIM) applications. The PIM application may manage email and calendar data for a user. In some embodiments, the PIM application may also manage user contact list data, task data, project data, notes data and other data. Project data may include email, tasks, appointments and other data that are grouped together (for example, a “client” project may include emails and appointments associated with a particular client). The PIM application and notification application may be implemented on the same hardware machine or separate machines.

In one embodiment, the PIM application may detect that user data has changed. The PIM application may detect the change in response to a local event or receiving a new message (or other unit of data) over a network from a remote computing device. The local event may be receiving user input by the PIM application, expiration of a timer, or some other local event. The new message from the remote computing device may be associated with a new email received for the user, a new calendar appointment, a new contact in an address book, a task becoming due, having less free time between now and when the task is due as compared to the time required (or scheduled) to complete the task or some other event.

When the PIM application detects that user data has changed, the PIM application may send a new data message to the notification application. In some embodiments, the new data message can contain the new or changed user data. In some embodiments wherein the new data message does not contain the new user or changed data, the notification application may send a request to the PIM application for the new or changed user data. The PIM application will then retrieve the new/changed user data and send that data to the notification application. In some embodiments, the PIM application may retrieve user data in response to detecting a user data change. Once the data is retrieved, the user data is provided to the notification application by the PIM application. The process for retrieving new or changed user data by a notification application is discussed in more detail below. Though the new data message may be discussed with reference to new data, it is understood that the new data message may contain new or changed data.

The display of the notification panel may change as the notification application transitions between different states. When the notification panel is first generated, the panel is in an “initial state” and displays the current user data. When new or changed user data is retrieved, the notification application transitions to a “new data” state and provides the new or changed data in the notification panel. In some instances, the “new data” state may correspond with the changed data (e.g., a “new mail” state or a “new task” state). Additionally, an alert associated with the changed data is provided in the notification panel while in a “new data” state. The alert may include a visual or audio indicator. Notification panels associated with different notification application states are discussed in more detail below with respect to FIGS. 3A-3C.

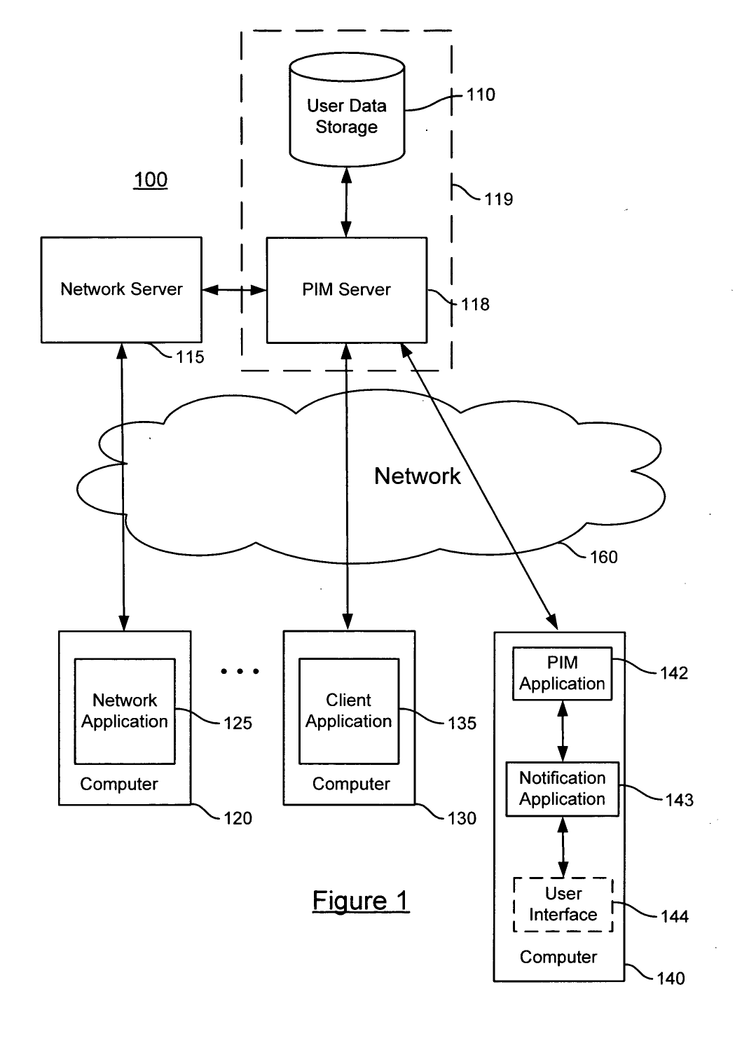

FIG. 1 illustrates an embodiment of a system for providing a unified notification panel. FIG. 1 includes user data storage 110, network server 115, PIM server 118, computers 120-140 and network 160. User data storage 110 and PIM server 118 can optionally be implemented as server 119. In one embodiment, network 160 may be implemented as the Internet. In one embodiment, network server 115 and PIM server 118 may send and receive information through network 160 (not illustrated).

User data storage 110 may store data and send and receive data and other information with PIM server 118. Alternatively, when user data storage 110 and PIM server 118 are implemented as a single server 119, user data storage 110 may send and receive data and other information with network server 115 and computers 130-140.

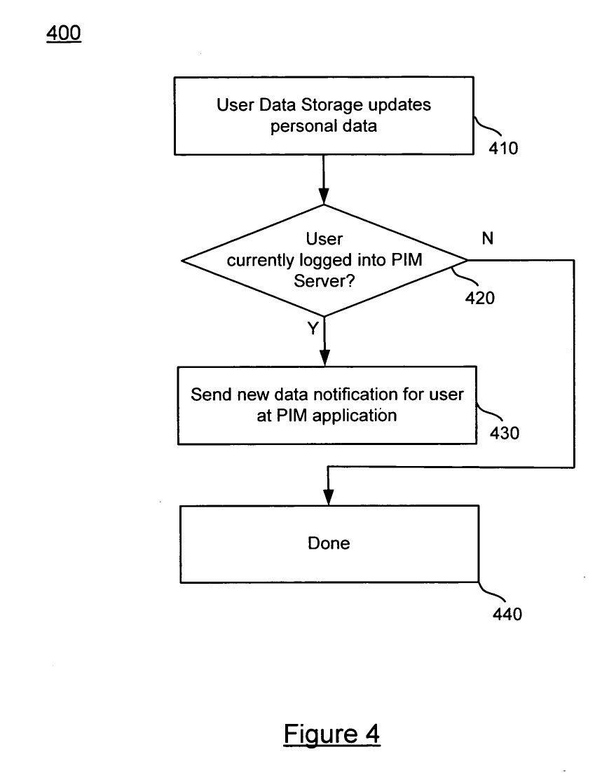

The data stored by user data storage 110 may include electronic mail data, calendar data, task data, projects data, notes data, address book data and other data associated with a user. User data storage 110 may send and transmit the data, as well-as transmit new data messages. The new data message may be generated by user data storage 110 in response to detecting a change in the stored data for a user. In one embodiment, the notification messages are transmitted as soon as new or changed data is detected. This is discussed in more detail below with respect to flow chart 400 of FIG. 4.

PIM server 118 provides a personal information management service to users. In one embodiment, the personal information management service is provided to users having account information stored with (or accessibly by) PIM server 118. The service may include an electronic mail service, a calendar management service and/or some other type of service. In some embodiments, the service may also allow a user to manage tasks, projects, and other time-dependent services.

PIM server 118 may send and receive messages with network server 115, user data storage 110 and computers 130-140. In particular, PIM server 118 may handle requests for user data from PIM application 142 of computer 140. When a data request is received, PIM server 118 retrieves the user data from user data storage 110. In some embodiments, PIM server 118 may be implemented as a mail server. The mail server may provide a mail service to users having an account with the mail service and retrieve requested mail messages and mail data from user data storage 110.

Network server 115 may send and receive information with computer 120 and PIM server 118 (or optionally server 119). In one embodiment, network server 115 may provide a network service over a network 160. The service may be an email service, instant messaging service, calendar service or some other service. In the case of a network-based email service, a user may send and receive email using network application 125 of computer 120. If a user of network application 125 sends an email to a user of PIM application 142, network server 115 would transmit the email data to PIM server 118. The email data would then be stored in user data storage 110.

Computers 120 and 130 include network application 125 and client application 135, respectively. Computer 120 may send and receive messages with network server 115. Network application 125 on computer 120 may be used to access a network service provided by network server 115. Computer 130 includes client application 135, and may send and receive information with PIM server 118. In one embodiment, client application 135 may be implemented as a client mail application, a client PIM application or some other application. In this case, client application 135 may send data, such as email data, to PIM server 118.

Each of applications 125 and 135 may be used to change user data for a user of PIM application 142. In one embodiment, a user of network application 125 or client application 135 may be an attendee of a meeting, sender of an e-mail, owner of a project task, a contact in the user's address book or have some other relationship with the user of PIM application 142. The user of application 125 or 135 may cancel, change or request a meeting with the user, send the user an email, change a project parameter, or perform some other action that affects the user data of the user of PIM application 142. As the user of application 125 or 135 performs an action that affects user data, changes in the data are transmitted to PIM server 118. PIM server 118 then sends the data to be stored at user data storage 110. User data storage 110 updates the user data and generates new data message for the user. The new data message is transmitted to PIM application 142 of computer 140. For example, if a contact changes the time of a meeting with the user, the new meeting time would be persisted in user data storage 110 and communicated to the user. This is discussed in more detail below.

Computer 140 includes PIM application 142, notification application 143, and user interface 144. Computer 140 may send and receive information with PIM server 118. In particular, computer 140 may receive new data messages for PIM application 142. In this case, PIM application 142 may establish a connection with PIM server 118 using the networking hardware and software of computer 140.

PIM application 142 is a personal information management application. PIM application 142 may include a back end application for sending and receiving messages and a front end application for providing a PIM user interface (not illustrated in FIG. 1). In one embodiment, PIM application 142 may be implemented with “Entourage” software provided by Microsoft Corporation, of Redmond Washington.

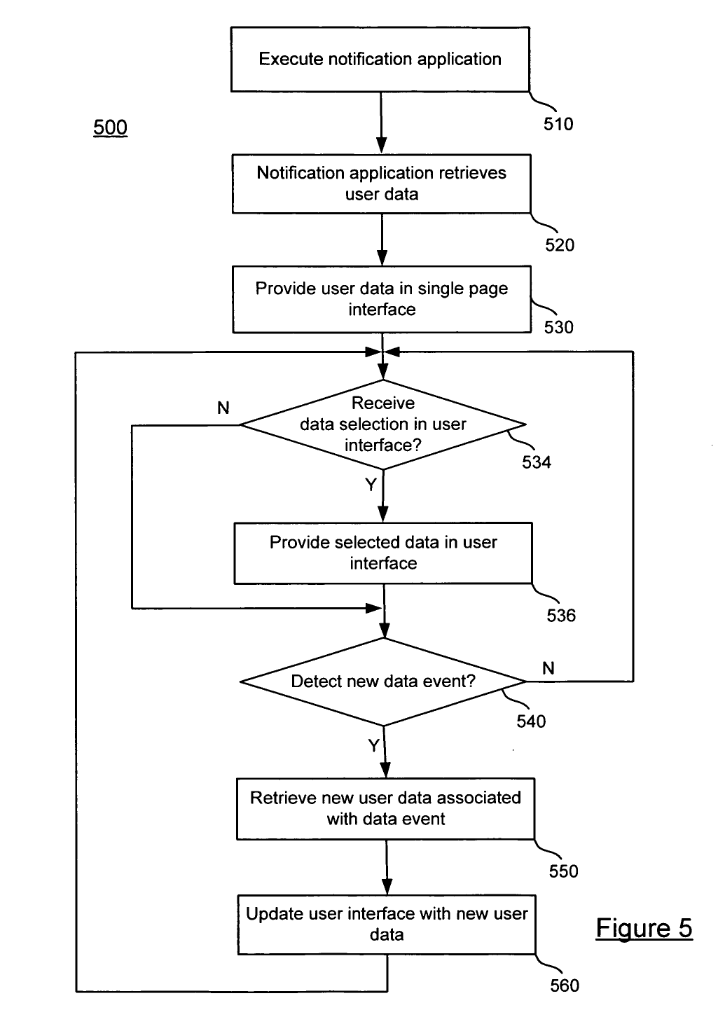

Notification application 143 provides a unified single page interface for displaying user data and may send and receive messages with PIM application 142. When notification application 143 receives a new data message from PIM application 142, notification application 143 retrieves the user data associated with the new data message. The user data may be retrieved directly from the new data message or by generating and sending a data request to PIM application 142. In another embodiment, Application 143 may communicate directly with PIM server 118 when PIM Application 142 is not running This is discussed in more detail below with respect to flow chart 500 of FIG. 5.

User interface 144 is a single page user interface that provides information regarding a user's personal information. In one embodiment, user interface 144 may include electronic mail data and calendar data for the user. In some instances, the user interface may also include any of user calendar data, task data, project data, address book data, and other data. In some embodiments, user interface 144 may “float” above any other application provided in a display device of a computing environment (i.e., the UI is visible to the user while another application has focus and is being used), be displayed in an alternative “dashboard” area (such as the Dashboard provided by on “OS X” by Apple Computer, Incorporated, of Cupertino, Calif., the auxiliary display or as a Gadget in “Windows Vista” by Microsoft Corporation. In other embodiments, user interface 144 can be configured as a conventional window layered amongst other windows on a computing system OS, or be pined to the a task bar in the provided as part of a desktop image provided by an operating system. User interface 144 provided by notification application 143 is discussed in more detail below with respect to FIGS. 3A-3C. In one embodiment, notification application 143 may be implemented with “MyDay” software provided by Microsoft Corporation of Redmond, Wash.

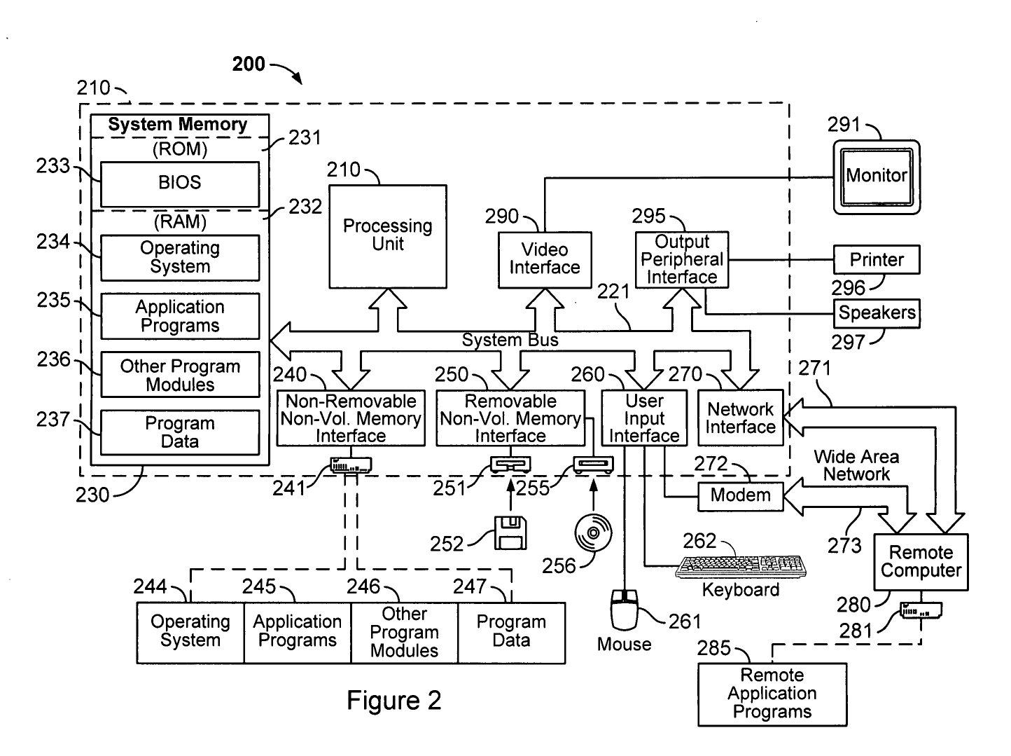

FIG. 2 illustrates an example of a suitable computing system environment 200 on which the present technology may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200. In one embodiment, computing system 200 of FIG. 2 can be used to implement user data storage 110, PIM server 118, network server 115 and computers 120-140 of FIG. 1.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, cell phones, smart phones, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

User data is tracked and provided in a single page user interface. FIG. 3A illustrates one embodiment of a single page user interface for providing personal data for a user. In one embodiment, the user interface of FIG. 3A may implement user interface 144 of FIG. 1 while notification application 143 is in an “initial data” state. User interface 300 includes a day calendar 310, appointment indicator 320, e-mail indicator 330, task indicator 340, clock 350, task list 360 and action buttons 371-376. Day calendar 310 includes a day timeline for the user. Day calendar 310 may display time in hours, minutes, days, weeks, or some other manner. In one embodiment, day calendar 310 displays the hours in a typical business day associated with the user. For example, in the embodiment shown in FIG. 3A, the user's typical business day spans from 9:00 A.M. to 5:00 P.M. Events scheduled for a user within the time displayed in day calendar 310 may be indicated within day calendar 310. In some cases, the events may include a visual highlight. For example, day calendar 310 includes visual highlights for the hours of 11:30 A.M. to 12:30 P.M., 1:00 P.M. to 2:00 P.M., and 4:00 P.M. to 4:30 P.M, indicating events scheduled for a user at these times. In some embodiments (not illustrated), the user interface of the present technology may display the first one hour of the next day. For example, if a user's work day is from 9:00 A.M. to 5:00 P.M., a timeline within the interface may show appointment, task and other information from 9:00 A.M. to 5:00 P.M. for the present day and 9:00 A.M. to 10:00 A.M. for the next day. In this embodiment, the interface provides information which allows the user to know of scheduled appointments, tasks, and other information that relates to the first hour of the next business day. The user may then use this information to plan for corresponding time period for the next business day.

Appointment indicator 320 indicates information associated with one or more user appointments. In the embodiment shown, appointment indicator 320 indicates information for the next user appointment. In particular, the indicator provides information that the next meeting for the user is in two hours. E-mail indicator 330 indicates information associated with the user's email account. In the embodiment illustrated, indicator 330 displays the number of unread emails for the user. Task indicator 340 provides information associated with user tasks. In one embodiment, indicator 340 displays the number of uncompleted tasks which are past due for the user. In another embodiment, indicator 340 may display the number of past due tasks, tasks due the current day or the next day, or other information. Clock 350 indicates the current time. Additionally, clock 350 indicates appointments associated with the current day for the user. The appointments highlighted within clock 350 correspond to the appointments highlighted in day calendar 310 for the user.

Task list 360 provides information regarding the most recent tasks for the user. In the embodiment shown, the most tasks include one completed task and two uncompleted tasks. For each task, a short description and a checkbox is provided. The checkbox is checked for the completed task and empty for the uncompleted tasks.

As discussed above, interface 300 may be displayed when notification application 143 is in an “initial data” state. Interface 300 may also be displayed when new task data for the user has been added, removed or changed. In this case, notification application enters a “new data” state, or “new task data” state, and the new task data is displayed in the interface. In some embodiments, the new data state can also be associated with a notification that there is less free time remaining until a particular task or appointment on the calendar than the time required to complete the task or prepare for the appointment. In this case, the user may indicate the time required to complete the task or prepare for the appointment, or the time required may be looked up from memory or storage using information provided by the user.

User selection of action buttons 371-376 initiate a task or action related to user data displayed in the notification panel of FIG. 3A. Selection of action buttons 371-372 and 374 initiate a user interface page of PIM application 142. Action button 371 initiates a “new mail” interface page, action button 372 initiates a “calendar view” interface page and action button 374 initiates a “task view” interface page. To initiate the PIM application interface page, notification application 143 sends a message to request the particular interface page in response to user input. Selection of action button 375 instructs PIM application 142 to send the currently selected user data to be printed at a printer. Selection of action button 373 initiates the display of a user interface for PIM application 142. Selection of action button 376 displays a control panel which allows a user to adjust display settings for the notification panel. In some embodiments, the new data or current/previous data could be provided or hosted in the notification application without sending invoking or sending a message to PIM application 142. In this case, the complete new data or function requested is provided or handled by notification application 143.

FIG. 3B illustrates an embodiment of a single page user interface which displays a new mail alert for a user. The interface of FIG. 3B may be displayed when notification application 143 transitions to a “new data” state from an “initial data” state. In particular, the interface of FIG. 3B may be displayed when notification application 143 transitions to a “new email” state. The transition to a “new email” state may be made in response to receiving new email data from PIM server 118. The interface of FIG. 3B includes the same day calendar 310, appointment indicator 320, email indicator 330, and task indicator 340 as those illustrated in user interface 300 of FIG. 3A. Additionally, interface 305 includes a date indicator 370 and a mail notification 380. Date indicator 370 indicates the month, date, and day for the user. In one embodiment, a user may configure the interface of FIGS. 3A or 3B to display either data indicator 370 or clock 350. Mail notification 380 provides information associated with an email for the user. In one embodiment, mail notification 380 is displayed in response to receiving a new email data in a data response by notification application 143. In another embodiment, mail notification 380 may be displayed in response to user selection of email indicator 330. In the embodiment illustrated, the mail notification information includes the email title, email sender and a summary of the email content.

Interface 305 also include panel button 382. User selection of panel button 382 causes a supplemental panel to be displayed in the user interface. The supplemental panel provides more detail for a portion of the user data. In some instances, the supplemental panel can provide more information for the most recently received new data (e.g., the most recent office events or appointments received by notification application 143). An example of an interface having a supplemental panel is illustrated in interface 308 of FIG. 3C. Other new events can include notification of a tasks that may not be completed before a deadline, the arrival of an assigned task, and a notification of an upcoming meeting or appointment.

FIG. 3C illustrates an embodiment of a single page user interface having a supplemental panel. In particular, the interface of FIG. 3C is an illustration of the interface FIG. 3B after panel button 382 is selected. The interface of FIG. 3C includes day calendar 310, appointment indicator 320, email indicator 330, task indicator 340, date indicator 370, and mail notification 380 as that illustrated in the interface of FIG. 3B. Additionally, the interface of FIG. 3C includes a supplemental panel 384 and panel button 390. In the embodiment illustrated, supplemental panel 384 includes task alerts 386 and 388. The task alerts provide more information for two most recent tasks for the user. The task alerts include the name of the task, the current status of the task, and when the task is due. For example, task alert 386 indicates that a task with a title of “Connect UX War Meeting,” is currently overdue and was scheduled to be completed on “4-26-05.” In other embodiments, a supplemental panel can provide information for other data, including email, contact, and other data. As discussed above, a supplemental panel is displayed in a user interface when a panel button (such as button 382 of FIG. 3B) is selected. The supplemental panel can be removed from the interface of FIG. 3C in response to user selection of panel button 390 located on the supplemental panel. Thus, if panel button 390 of supplemental panel 384 is selected, the user interface provided will resemble that of FIG. 3C (a user interface without a supplemental panel).

As discussed above, notification application 143 may receive a new data message when user data changes are detected by PIM application 142. In one embodiment, the new data message may be initiated by PIM application 142 or user data storage 110. FIG. 4 is a flowchart illustrating an embodiment for generating a new data message for a user by user data storage 110. First, user data storage 110 updates user personal data at step 410. The updated user data may be received by user data storage 110 from any of several sources. For example, an email may be sent to the user of PIM application 142 from user network application 125. In this case, network server 115 transmits mail data to PIM server 118. PIM server 118 then sends the mail data to user data storage 110 to be stored. In another case, client application 135 may send data to PIM server 118 regarding a new meeting with the user of PIM application 142. The new meeting data would be stored as user calendar data in user data storage 110. After PIM server 118 sends the data to user storage device 110, user storage device 110 saves the user data.

After user data storage 110 updates user data, user data storage 110 determines whether the user associated with the updated user data is currently logged into PIM server 118 at step 420. The user may be logged into the PIM server if the user has started PIM application 142 on computer 140 and PIM application 142 has established a connection with PIM server 118. In some instances, a connection between PIM application 142 and PIM server 118 requires the appropriate login information to be provided by the user of PIM application 142. The database may determine whether the user is currently logged into the PIM application by querying PIM server 118 with a user status request. The user status request may include identification information for the user and other data. PIM server 118 receives the status request, determines if a user associated with the user identification information is currently logged in, and sends a user status response to user data storage 110. If the user is determined to be logged into PIM server 118 at step 420, flow chart 400 continues to step 430. If the user is not logged in, flow chart 400 ends at step 440.

A new data message for a user is sent to PIM application 142 at step 430. In one embodiment, user data storage 118 generates the new data message in response to determining that the user associated with the updated data is logged into PIM server 118 at step 420. The new data message includes user identification data and other data. In some embodiments, the other data may include the new data itself (e.g., unread email information, new task information, etc.), user identification information, data identification information, and other data. Processing of the data by notification application 143 is discussed in more detail below with respect to FIG. 5.

To transmit the new data message to PIM application 142, the new data message is first transmitted from user data storage 110 to PIM server 118. The new data message is then transmitted by PIM server 118 to PIM application 142. In one embodiment, PIM server 118 accesses the user identification information in the new data message and determines an IP address associated with the logged in user. PIM server 118 then sends the new data message to the user IP address over network 160. Processing of the new data notification by PIM application 142 is discussed in more detail below with respect to step 550 of flow chart 500 and flow chart 600.

When PIM application 142 receives new user data, alerts for the new user data are provided in a single page user interface. The single page user interface may be implemented as user interface 144 of FIG. 1, and may resemble the interfaces of FIGS. 3A-3C. FIG. 5 is a flowchart illustrating an embodiment for providing data in a single page user interface. The flowchart of FIG. 5 begins when notification application 143 is run at step 510. Starting the application may include confirming that PIM application 142 has established a connection with PIM server 118 over network 160. To configure the connection, notification application 143 may send a confirmation message to PIM application 142. PIM application 142 may confirm a connection with PIM server 118 by sending a confirmation response to notification application 143.

Next, notification application 143 retrieves user data at step 520. In one embodiment, notification application 143 transmits a user data request to PIM application 142. In some embodiments, the user data request may be included in the confirmation message sent to PIM application 142 at step 510.

In some embodiments, all or a portion of the initial user data may be retrieved by PIM application 142 from local memory in computer 140. PIM application 142 then sends the user data to notification application 143 in a data response. Notification application 143 receives the data response and retrieves the user data from the response. The retrieved data is then placed in a single page user interface such as user interface 144.

PIM application 142 may retrieve locally stored user data including task data, project data, notes data, old mail data, old calendar data, and parameters related to providing the user data. The calendar data may include user calendar data for the previous day, current day, and following day. The task data may include all user tasks. In some embodiments, a maximum number of tasks are stored, with tasks due the current day and the following day having priority than other tasks. The project data may include lists of projects and meta-data associated with projects. For example, the meta-data may contain data indicating which emails or tasks are associated with a particular project. Note data may include a list of all the notes associated with a user. In one embodiment, a maximum number of notes are stored, such as fifty. The mail data may include the number of unread mail messages, the unread mail title, sender and a limited portion of the email (e.g., the fist 20 characters of the email content). The mail data may also include user identification and password information to allow access to the user mail account.

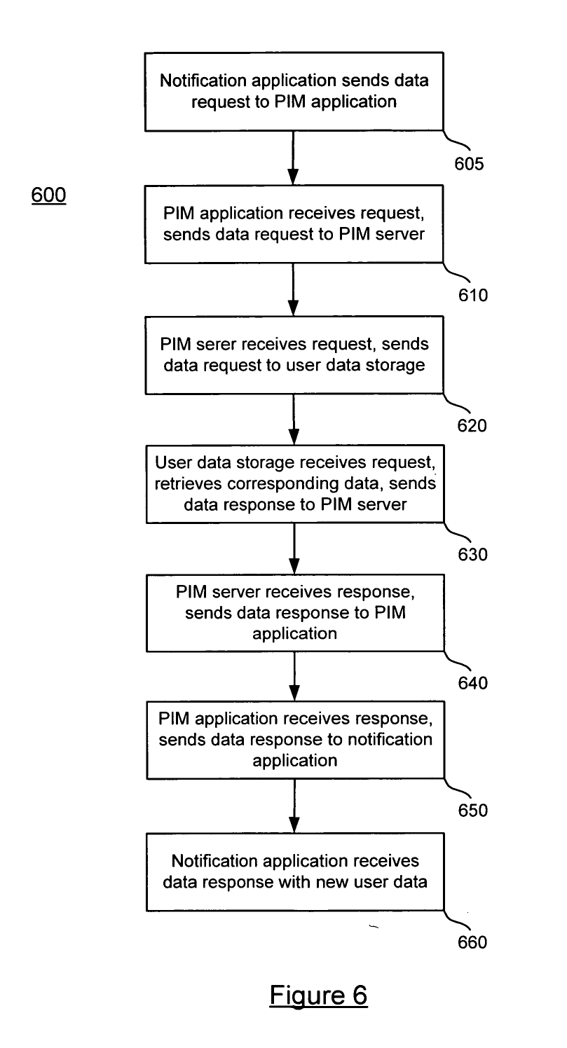

In some embodiments, PIM application 142 may access all or a portion of the user data to be displayed from user data storage 110. Data that may be retrieved from a remote source, such as user data storage 110, includes email data, new calendar data, contact list data and other data. When the user data is accessed from user data storage 110, PIM application 142 generates a user data request. The user data request may include user identification data and other data. In one embodiment, the initial user data request from PIM application 142 includes a parameter indicating that updates are requested for all user data types (e.g., email data, calendar data, contact book data and any other data stored by user data storage 110). The user data request for user data storage 110 is received and processed by PIM server 118. Server 118 then sends a user data response to PIM application 142. This is discussed in more detail with respect to flow chart 600 of FIG. 6.

After local and remote user data is retrieved, the user data is provided in a single page interface at step 530. With respect to FIG. 1, notification application 143 provides the retrieved user data in user interface 144. Examples of a suitable single page interface in which the data can be provided are in FIGS. 3A-3C. When the user retrieved user data is provided for the first time when running notification application 143, the application is transitioned to an “initial data” state.

A determination is made as to whether a data selection is received in the user interface at step 534. In one embodiment, a user may select a portion of a single page interface associated with a type of user data. For example, selectable portions of a single page interface may include appointment indicator 320, e-mail indicator 330, task indicator 340, clock 350 and task list 360 of the interface of FIG. 3A. In another embodiment, a user may select an action button such as action buttons 371-376 of FIG. 3A. The selection may be made by using an input device to place a cursor over the appropriate portion of the interface. If no data selection is received in the user interface, the flow chart of FIG. 5 continues to step 540.

If a data selection is received, the selected data is provided in the user interface at step 536. In one embodiment, the selected data is provided in more detail within the interface. For example, if email indicator 330 is selected in the interface of FIG. 3A, the interface of FIG. 3B with mail notification 380 may be provided. In this case, mail notification 380 provides more detail for selected email indicator 330. In other embodiments, other data associated with other data indicators may be provided (e.g., appointment information in response to selecting appointment indicator 320, task information in response to selecting task indicator 340, etc.). After providing the selected data, the flow chart of FIG. 5 continues to step 540.

If an action button is selected, the appropriate action will be performed with respect to the user data in user interface 144. For example, if user action button 375 associated with printing is selected, a message will be sent to PIM application 142 to print the user data currently highlighted in notification panel 143 (e.g., email data or task data). In some embodiments, notification application 143 may send a message to PIM application 142 to print out a collection of all the data displayed in the interface, in a layout which is optimized for printing.

A determination is made as to whether a new data event is detected at step 540. In one embodiment, a new data event is detected if PIM application 142 receives a new data message from user data storage 110 or detects a user data change locally. In some embodiments, a new data event is detected if a new data message is received by notification application 143 from PIM application 142. In this case, PIM application 142 may send a new data message to notification application 143 in response to detecting a change in user data stored locally or in response to receiving a new data message from PIM server 118. The new data message may include user identification information, new data identification information, timestamp information associated with the new data and other data. In some embodiments, the new data message received by PIM application 142 may include the new data itself. For example, user data storage 110 may include mail data in a new data message for a user if the particular email protocol used by PIM application 142 requires it. User data may be changed locally when a user of PIM application 142 performs an action that changes the locally stored user data. User actions that may change the locally stored user data include scheduling or changing an appointment, reading or deleting an unread email, creating, completing or deleting a task, or some other action. When the new data message received by PIM application 142 is initiated by user data storage 110, the message is generated as discussed above with respect to step 430 of flow chart 400. If a new data event is not detected at step 540, flowchart 500 returns to step 534.

If a new data event is detected at step 540, operation continues to step 550. When a new data event is detected, notification application 143 transitions to a “new data” state. The “new data” state may be associated with a particular type of data, such as email data, task data, or other data. In any case, when notification application 143 transitions to a new data state, retrieval of the new data associated with the new state is initiated.

User data associated with the new data event is retrieved by notification application 143 at step 550. In one embodiment, notification application 143 retrieves the new user data from the new data message (if the message contains the data). In some embodiments, notification application 143 generates and transmits a data request to PIM application 142. The data request includes data identification information and user identification information received by notification application 143 at step 540. In some embodiments, the data request may also include time stamp data. The time stamp data my be associated with the last time user data was retrieved locally by PIM application 142, the last time user data was retrieved by user data storage 110 on behalf of the user, or both.

If the new user data is stored locally, PIM application 142 retrieves the new data from computer 140 memory in response to receiving the data request. The new data is then packaged into a data response and sent to notification application 143. In one embodiment, PIM application 142 may retrieve the new data using the data identification information in the data request. In some embodiments, PIM application 142 accesses the appropriate data by retrieving stored user data that has changed since the last data request sent by notification application 143.

If the new data is stored remotely, PIM application sends a data request to PIM server 110. PIM server 110 receives the request, processes the request, and transmits a data response to PIM application 142. This is discussed in more detail below with respect to flowchart 600 of FIG. 6.

Next, user interface 144 is updated to display the new user data at step 560. Updating user interface 144 may include making changes to portions of the user interface associated with the data retrieved at step 550. For example, with respect to the interface of FIG. 3A, if the new data included a new email for the user, mail indicator 330 would be changed such that number of unread emails would be increased by one. In another embodiment, mail indicator may also be displayed in bold text, a different color, or with some other indicator to show that the data has changed. In another example, if the new data indicated that a meeting for the user had been cancelled, day calendar 310 may indicate this with either a new indicator associated with a cancelled meeting (such as a red bar extending over the timeline associated with the meeting) or by removing a previously displayed indicator associated with the meeting. After user interface 144 is updated with the new user data, flowchart 500 returns to step 540 where it determines whether a data selection is received through the user interface.

FIG. 6 is a flowchart illustrating an embodiment for retrieving new or changed data from a remote storage device. In one embodiment, flow chart 600 illustrates more detail for step 520 and step 550 of flowchart 500 for retrieving new user data from user data store 110. Thus, the flowchart of FIG. 600 describes how new data may be received for both an initial data request upon start-up of notification application 143 and in response to a new data message received while notification application 143 is running.

First, notification application 143 sends a data request to PIM application 142 at step 605. The data request may include user identification information, data identification information, time stamp data and other data. When the data request is in response to a new data message, the data identification information may be retrieved from the new data message. Additionally, when the data request is in response to a new data message, the time stamp information indicates the last time user data storage 110 received a data request on behalf of the user of PIM application 142. In one embodiment, when the data request is sent at start-up of notification application 143, no data identification information or time stamp data is provided.

PIM application 142 receives the data request and sends a data request to PIM server 118 at step 610. The data request sent by PIM application 142 includes the data contained in the data request from notification application 143. PIM server 118 receives the data request from PIM application 142 and sends a data request to user data storage 110 at step 620. The data request sent to user data storage 110 may include the same data contained in the data request sent by PIM application 142.

Next, user data storage 110 receives the data request from PIM server 118, retrieves the corresponding new data and sends the new data to PIM server 118 in a data response. In one embodiment, user data storage 110 retrieves user identification information from the data request and retrieves the corresponding data. In this case, user data storage 110 contains a list of the data which has been updated for a user and not provided to the user in a data response. In another embodiment, user data storage 110 retrieves the data using the data identification information contained in the data request. For example, the data identification information may indicate an email, a contact address, or some other information. The particular email associated with the data identification information is then retrieved by user data storage 110. In some embodiments, user data storage 110 will retrieve user data which has been updated since the time indicated by the time stamp included in the data request. User data storage will then provide the updated data in the data response as well as a current time stamp associated with the new data request.

In one embodiment, the data response may include the user identification information, data identification information, and the new user data retrieved. The user identification and data identification may be the same as that provided in the data request received from PIM application 142. In some embodiments, the data response may also include a time stamp associated with the current data retrieved from user data storage 110.

After receiving the data response from user data storage 110, PIM server 18 sends the data response to PIM application 142 at step 640. PIM application 142 receives the data response and sends the data response to notification application 143 at step 650. Notification application receives the data response at step 660. Once received, the new user data is provided in user interface 144 as discussed with respect to step 560 in flow chart 500.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for tracking notification events for user data, comprising:
accessing user data including electronic mail data and calendar data;
providing the user data in a single page of a user interface; and
displaying an alert in the single page of the user interface, the alert generated in response to detecting a change in the user data.

2. The method of claim 1, wherein said step of accessing user data includes:
sending a data request to a personal information management application.

3. The method of claim 1, wherein said step of accessing user data includes:
receiving user data from a remote server.

4. The method of claim 3, wherein the user data includes time stamp data associated with a data request received by the remote server.

5. The method of claim 1, wherein said step of displaying an alert includes:
transmitting a user data request in response to receiving a new data message initiated by a remote server.

6. The method of claim 1, wherein said step of displaying an alert includes:
generating a data request for user data stored at a remote server.

7. The method of claim 1, wherein said step of displaying an alert includes:
displaying an alert associated with each of mail data and calendar data in the single page.

8. The method of claim 1, wherein said step of displaying an alert includes:
providing updated user data in the single page user interface.

9. One or more processor readable storage devices having processor readable code embodied on said processor readable storage devices, said processor readable code for programming one or more processors to perform a method comprising:
displaying user data in a single page of an interface, the user data including user electronic mail data and user calendar data;
receiving a new data message; and
providing an indicator in the single page of the interface in response to the new data message.

10. The one or more processor readable storage devices according to claim 9, wherein the new data message includes data identification information.

11. The one or more processor readable storage devices according to claim 9, wherein providing an indicator includes:
providing an indicator which indicates there is no longer enough free time to complete a scheduled task.

12. The one or more processor readable storage devices according to claim 9, wherein the new data message is initiated by a remote server.

13. The one or more processor readable storage devices according to claim 9, wherein the new data message is received from a personal information management application.

14. The one or more processor readable storage devices according to claim 9, wherein said step of providing an indicator includes:
retrieving new user data associated with the new data message; and
providing the new user data in the single page interface.

15. The one or more processor readable storage devices according to claim 9, wherein said step of retrieving new user data includes:
retrieving the new user data from local memory.

16. The one or more processor readable storage devices according to claim 9, wherein said step of retrieving new user data includes:
retrieving the new user data from a remote server.

17. An apparatus for processing data, comprising:
a communication interface;
a storage device; and
one or more processors in communication with said storage device and said communication interface, said one or more processors perform a method comprising:
providing electronic mail data and calendar data in a single page user interface, the electronic mail data and calendar data retrieved from a personal information management application; and
displaying a notification in the single page user interface in response to detecting a changed state in the personal information management application.

18. The apparatus of claim 17, the method further comprising:
provide a notification for each of the electronic mail data and calendar data simultaneously.

19. The apparatus of claim 17, the method further comprising:
receiving input in the single page user interface; and
sending a message to the personal information management application to perform an action in response to the user input.

20. The apparatus of claim 17, the method further comprising:
receiving confirmation data in response to the initial data, the confirmation data indicating the personal information management application has established a connection with a remote server.
